(19) United States
(12) Patent Application Publication
(10) Pub. No.: US 2011/0232280 A1
(43) Pub. Date: Sep. 29, 2011

(54) TURBOCHARGER DIVERTER VALVE

(75) Inventor: Todd M. Zuccone, Fountain Hills, AZ (US)

(73) Assignee: Evolution Motorsports, Tempe, AZ (US)

(21) Appl. No.: 13/071,058

(22) Filed: Mar. 24, 2011

Related U.S. Application Data
(60) Provisional application No. 61/317,156, filed on Mar. 24, 2010.

(51) Int. Cl. F02B 37/00; F16K 15/00

(52) U.S. Cl. 60/605.1; 137/455

(57) ABSTRACT

A piston actuated diverter valve is employed to recirculate air through a turbocharger compressor when the device is not activated in an engine. An example diverter valve includes a housing forming a cylinder. A piston is arranged within the cylinder and an aperture passes from an exterior of the housing into the cylinder. A conduit is connected to the cylinder such that a pressurized fluid in the conduit acts to move the piston within the cylinder to cover and/or uncover the aperture.

This application claims the benefit of U.S. Provisional Application No. 61/317,156, filed Mar. 24, 2010, which is hereby incorporated by reference in its entirety.

### TECHNICAL FIELD

This disclosure relates to turbochargers employed in internal combustion engines.

### BACKGROUND

Superchargers operate to increase the density of air entering an engine to increase the power output of the engine. Superchargers include compressors that may be employed for forced-induction of an internal combustion engine. Turbochargers are one type of supercharger in which the compressor is powered by a turbine, which, in turn, is driven by the exhaust gases of the engine, rather than with direct mechanical drive as with many other superchargers. Automobiles including some types of turbochargers, e.g. variable geometry turbochargers (VTGs), may employ a diaphragm boost recirculation valve, which is sometimes referred to as a diverter, anti-surge, bypass, blow-off valve (BOV) or dump valve. Turbocharger diverter valves circulate air through the system when the turbocharger is not in use, e.g. when the automobile engine is operating at speeds and engine frequencies (revolutions per minute, or, RPMs) that do not call for activation of the turbocharger. This prevents pressure build-up in the turbocharger when the throttle valve is closed. In this manner, the diverter valve acts as a pressure relief valve. The diverter valve also keeps the turbocharger spinning at high speeds.

Originally such diverter valves are designed and fabricated to withstand the original equipment manufacturer's (OEM) specifications with respect to turbocharger boost pressure, airflow, and overall power output. However, when a turbocharged automobile undergoes certain aftermarket modifications, as is common with some classes of automobiles such as exotic sports cars, the OEM diaphragm diverter valve may begin to fail by seizing and/or leaking fluid from the pressurized turbocharger system.

### SUMMARY

In general, this disclosure is directed to piston actuated diverter valves that may be employed to recirculate air through a turbocharger compressor when the device is not activated in an engine.

In one example, a turbocharger diverter valve includes a housing forming a cylinder. A piston is arranged within the cylinder and an aperture passes from an exterior of the housing into the cylinder. A conduit is connected to the cylinder such that a pressurized fluid in the conduit acts to move the piston within the cylinder to at least one of cover or uncover the aperture.

In another example, a turbocharger includes a turbine and a compressor operatively connected to the turbine. A diverter valve is connected between an inlet and an outlet of the compressor. The turbocharger diverter valve includes a housing, a piston, an aperture, and a conduit. The housing forms a cylinder. The piston is arranged within the cylinder and the aperture passes from an exterior of the housing into the cylinder. The conduit is connected to the cylinder such that a pressurized fluid in the conduit acts to move the piston within the cylinder to at least one of cover or uncover the aperture.

In another embodiment, an internal combustion engine includes a turbocharger comprising an intake manifold, a turbine, a compressor operatively connected to the turbine, and a diverter valve connected between an inlet and an outlet of the compressor. The turbocharger diverter valve includes a housing, a piston, an aperture, and a conduit. The housing forms a cylinder. The piston is arranged within the cylinder and the aperture passes from an exterior of the housing into the cylinder. The conduit is connected to the cylinder and to the intake manifold such that a fluid pressure within the intake manifold acts to move the piston within the cylinder to at least one of cover or uncover the aperture.

The details of one or more examples of this disclosure are set forth in the accompanying drawings and the description below. Other features, objects, and advantages of examples in accordance with this disclosure will be apparent from the description and drawings, and from the claims.

### BRIEF DESCRIPTION OF DRAWINGS

FIG. 1 is a schematic illustration of an internal combustion engine including a turbocharger.

FIG. 2 is a schematic illustration of the turbocharger of FIG. 1 including a diverter valve.

FIG. 3 is a schematic illustration of the diverter valve of FIG. 2.

FIG. 4 is a perspective view of an example diverter valve appropriate for use in turbochargers.

### DETAILED DESCRIPTION

The following examples include turbocharger piston actuated diverter valves that are employed to recirculate air through the turbocharger compressor when the device is not activated in an engine. The disclosed piston actuated diverter valves provide a robust design that facilitates use of the valves across a wide range of engine and turbocharger operating conditions. In particular, the disclosed example valves may operate effectively in a wider range of turbocharger boost pressures, airflows, and overall power output than prior designs.

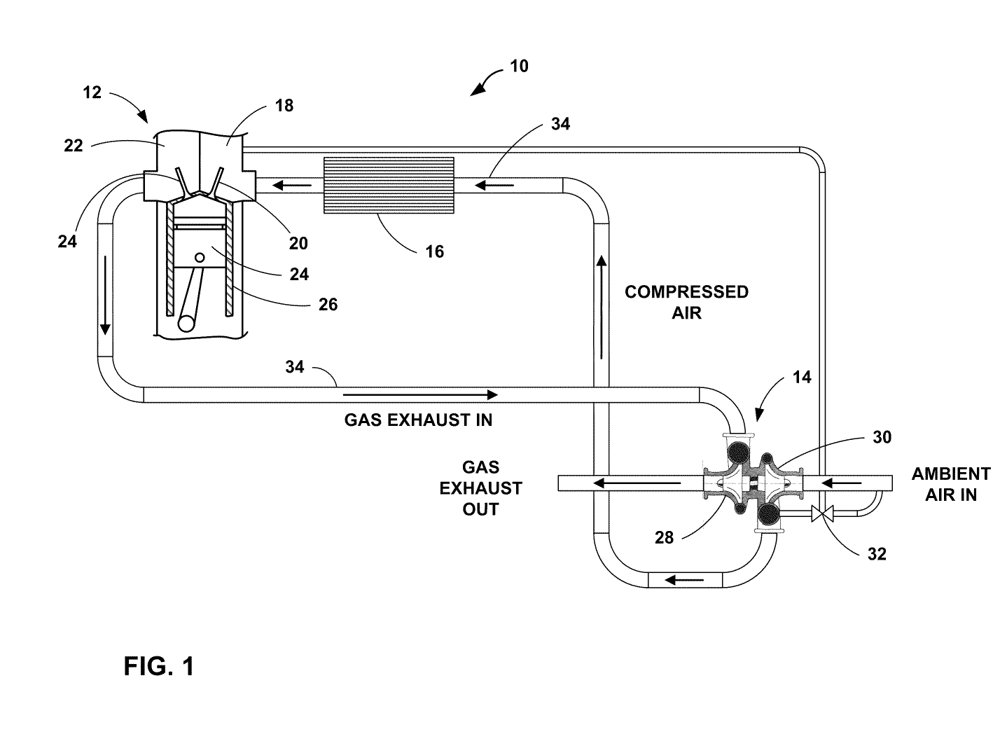

FIG. 1 is a schematic illustration of internal combustion engine 10 including engine block 12, turbocharger 14, and intercooler 16. In FIG. 1, engine block 12 includes intake manifold 18 and intake valve 20, exhaust manifold 20 and exhaust valve 22, piston 24, and cylinder 26. Although only one cylinder 26 is shown in FIG. 1 for illustrative purposes, engine 10 may and commonly will include multiple cylinders, e.g. four, six, or eight cylinders. Turbocharger 14 includes turbine 28, compressor 30 and diverter valve 32. In some examples, an internal combustion engine may include more than one intake and exhaust valve, e.g. two intake valves and two exhaust valves for each cylinder, which is sometimes referred to as a quattrovalve engine. The inlet of turbocharger 14 is connected to exhaust manifold 20 via conduit 34. Similarly, the outlet of turbocharger 14 is connected to intercooler 16, which is connected to intake manifold 18 of engine block 12. Diverter valve 32 is connected to and actuated by pressure conditions in intake manifold 18 via conduit 35.

Generally speaking, during operation of engine 10, turbine 28 of turbocharger 14 is driven by exhaust gas from cylinder 26. Turbine 28 spins compressor 30, which draws in and compresses ambient air to be transmitted through conduit 34 to intercooler 16. The compressed air from turbocharger 14 is cooled in intercooler 16 before being transmitted to intake manifold 18, in which it is mixed with fuel. The compressed air-fuel mixture enters cylinder 26 through intake valve 20 and is ignited in the cylinder by, e.g. a spark plug (not shown) to drive piston 24 down. The linear movement of piston 24 caused by ignition of the air-fuel mixture in cylinder 26 is translated into rotational movement, e.g. via a crank shaft, which is used to drive a vehicle that includes engine 10, e.g. an automobile or an aircraft. Employing turbocharger 14 and intercooler 16 to compress and cool the intake air in engine 10 can provide significant performance gains over normally aspirated vehicles.

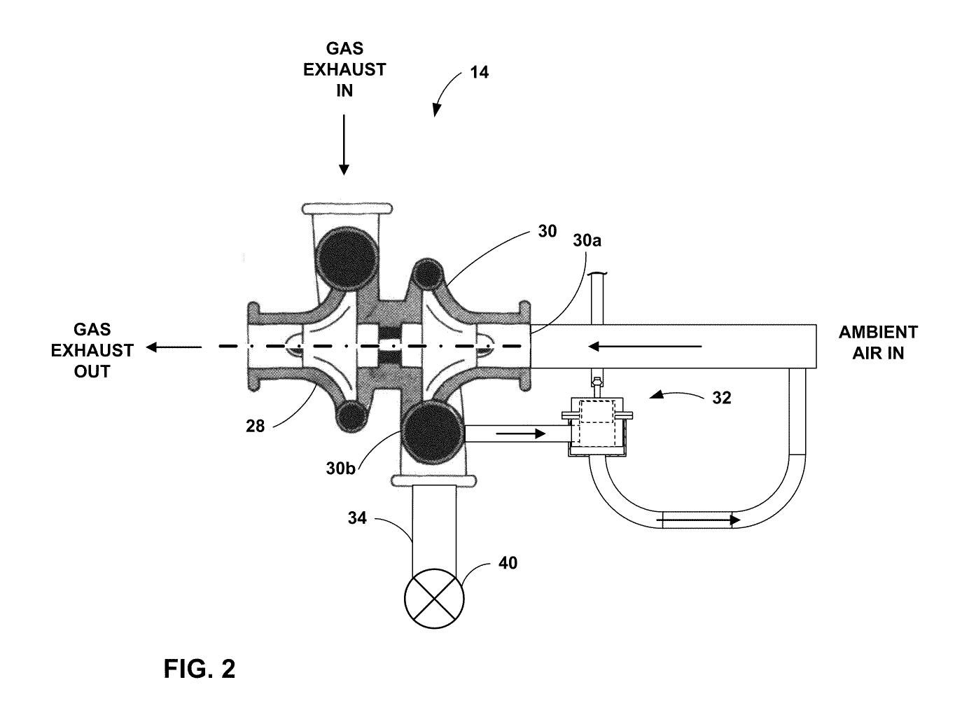

FIG. 2 is a schematic illustration of turbocharger 14 including turbine 28, compressor 30, and diverter valve 32. In some examples of the system of FIG. 1, engine 10 may include a mechanism that activates and deactivates turbocharger 14 at the appropriate operating conditions, e.g. particular speed and engine frequency (e.g. revolutions per minute, or, RPM) ranges. Engine 10 may, e.g., include throttle valve 40 that opens to activate turbocharger 14 by allowing compressed air from compressor 30 to be transmitted to intercooler 16 and onto intake manifold 18 and closes to deactivate use of the compressed air coming out of the turbocharger. When throttle valve is open 40 and turbocharger 14 is activated to provide compressed air to engine block 12, diverter valve 32 is closed to allow ambient air that is drawn into and compressed by compressor 30 to flow into conduit 34 and onto intercooler 16. However, as illustrated in FIG. 2, when throttle valve 40 of engine 10 is closed, diverter valve 32 opens to recirculate compressed air from outlet 42 of compressor 30 to the ambient air inlet of the compressor, thereby continually circulating air from inlet to outlet and back to the inlet until the throttle valve is opened again. Diverter valve 32 thereby prevents pressure build-up in the turbocharger when throttle valve 40 is closed and the compressed air produced by compressor 30 is effectively blocked. Additionally, because the compressed air blocked from flowing out of compressor 30 by throttle valve may flow back into the compressor and cause the turbocharger to slow or stop, diverter valve 32 may also act to keep the turbocharger spinning at high speeds even in interim periods during which the turbocharger is not activated.

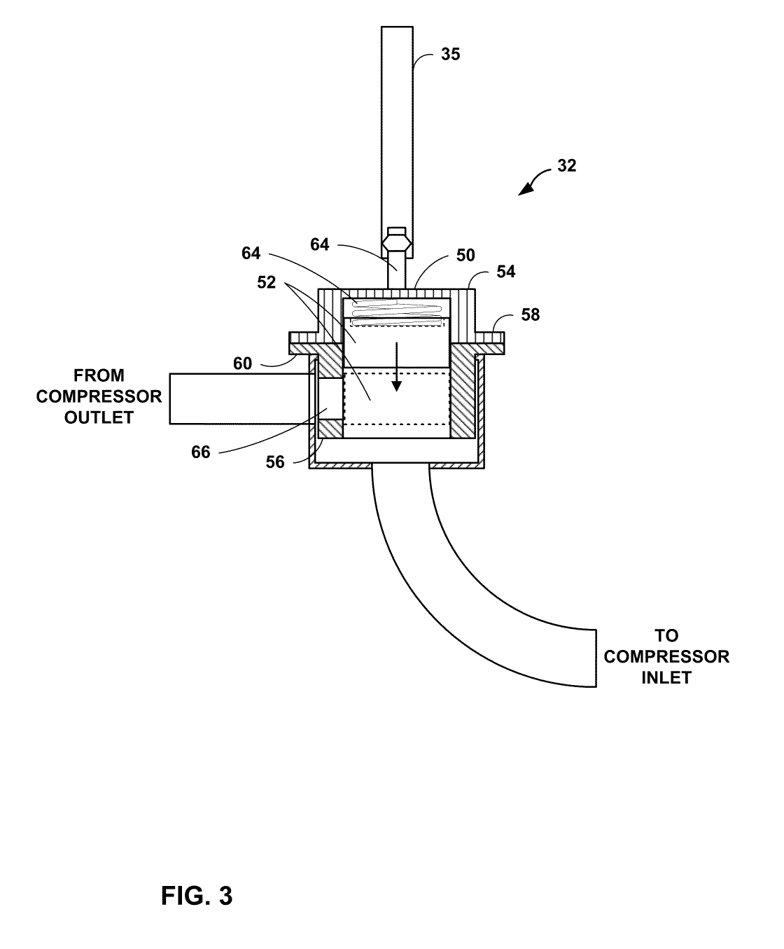

FIG. 3 is a schematic illustration of diverter valve 32 including housing 50 and piston 52. Housing 50 includes first and second halves 54, 56. First housing half 54 includes flange 58. Similarly, second housing half 56 includes flange 60. Generally speaking, flange 58 of first housing half 54 is connected to flange 60 of second housing half 56. Connected first and second housing halves 54, 56 form cylinder 62, in which piston 52 is arranged. Additionally, first housing half 56 includes nipple 64 and second housing half 56 includes port 66. Conduit 35 is connected between nipple 66 an intake manifold 18 (not shown) of engine 10. In some examples, conduit 35 may be releasably press fit over nipple 66.

Operation of diverter valve 32 is controlled by the pressure conditions in intake manifold 18 of engine 10 of FIG. 1. In particular, a net positive pressure in intake manifold 18 may act on piston 52 of diverter valve 32 via conduit 35 to drive the piston down and cover port 66, thereby closing the diverter valve. The closed position of diverter valve 32 is represented in FIG. 3 by piston 52 in dashed line in the down position. Positive pressure in intake manifold 18 may generally correspond to throttle valve 40 being open such that diverter valve 32 is closed to allow ambient air that is drawn into and compressed by compressor 30 to flow into conduit 34 and onto intercooler 16 when the throttle vale is open. Conversely, a net negative pressure in intake manifold 18 may act on piston 52 of diverter valve 32 via conduit 35 to retract the piston up and uncover port 66, thereby opening the diverter valve. The open position of diverter valve 32 is represented in FIG. 3 by piston 52 in solid line in the up or retracted position. Negative pressure in intake manifold 18 may generally correspond to throttle valve 40 being closed such that diverter valve 32 is open to recirculate compressed air from outlet 42 of compressor 30 to the ambient air inlet of the compressor, thereby continually circulating air from inlet to outlet and back to the inlet until the throttle valve is opened again.

In some examples, opening and closing diverter valve 32 via piston 52 may be assisted by biasing piston 52 in either an open or closed position. For example, piston 52 may be biased down into the closed position for diverter valve 32. In another example, piston 52 may be biased up into the open position for diverter valve 32. In one example, piston 52 may be biased by a compression spring, e.g. helical coil spring 53 shown in FIG. 3. In another example, piston 52 may be biased by employing a canted coil spring that may exhibit a constant spring force over a relatively large range of displacements.

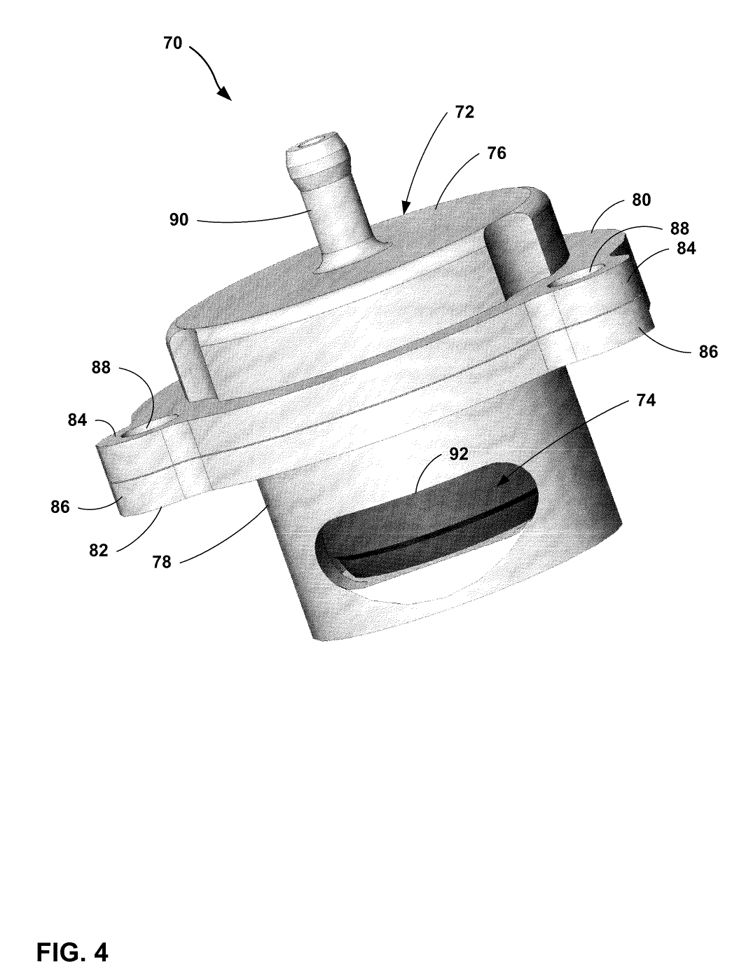

FIG. 4 is a perspective view of example diverter valve 70 appropriate for use in turbochargers employed in internal combustion engines, e.g. turbocharger 14 of engine 10 of FIG. 1. Diverter valve 70 includes housing 72 and piston 74. Housing 72 includes first and second halves 76, 78. Although diverter valve 70 includes generally curvilinear, and, in particular cylindrical housing 72, other examples may include alternatively configured housings. For example, a diverter valve according to this disclosure may include a rectilinear housing. First housing half 76 includes flange 80. Similarly, second housing half 78 includes flange 82. Generally speaking, flange 80 of first housing half 76 is connected to flange 82 of second housing half 78. In the example of FIG. 4, flange 80 and flange 82 each include complementary tabs 84 and 86, respectively. Tabs 84 and 86 each include apertures 88, through which fasteners may be arranged to connect first and second housing halves 76, 78, as well as, in some examples, to connect diverter valve 70 to another structure. In some examples, flanges 80 and 82 may include three or more tabs spaced approximately equidistant around a periphery of the flanges. Connected first and second housing halves 76, 78 form a cylinder (not shown), in which piston 74 is arranged. Additionally, first housing half 76 includes nipple 90 and second housing half 78 includes port 92.

The foregoing examples include turbocharger piston actuated diverter valves that provide a robust design to facilitate use across a wide range of engine and turbocharger operating conditions. The piston actuated diverter valves described may operate effectively in a wider range of turbocharger boost pressures, airflows, and overall power output than prior designs. As such, turbochargers employing such piston actuated valves may facilitate greater performance enhancements via increased boost pressures and airflows with a decreased risk of valve failure.

Various examples have been described. These and other examples are within the scope of the following claims.

1. A turbocharger diverter valve comprising:
a housing forming a cylinder;
a piston arranged within the cylinder;
an inlet aperture passing from an exterior of the housing into the cylinder;
an outlet aperture passing from the exterior of the housing into the cylinder; and
a conduit configured to provide a pressurized fluid to the cylinder via the inlet aperture such that the fluid acts to move the piston within the cylinder to at least one of cover or uncover the outlet aperture.

2. The diverter valve of claim 1, further comprising an intake manifold to which the conduit is connected.

3. The diverter valve of claim 1 further comprising a resilient member arranged and configured to bias a position of the piston within the cylinder.

4. The diverter valve of claim 3, wherein the biased position of the piston causes the piston to at least one of cover or uncover the outlet aperture.

5. The diverter valve of claim 3, wherein the resilient member comprises a coil spring.

6. The diverter valve of claim 5, wherein the coil spring comprises a canted coil spring.

7. The diverter valve of claim 5, wherein the coil spring comprises a helical coil spring.

8. The diverter valve of claim 1, wherein the housing comprises a first half connected to a second half.

9. The diverter valve of claim 8, wherein each of the first and second halves comprise a flange, and wherein the flange of the first half is connected to the flange of the second half.

10. The diverter valve of claim 1, wherein the housing comprises a nipple protruding from and configured to releasably connect the housing to the conduit.

11. A turbocharger comprising:
a turbine;
a compressor operatively connected to the turbine; and
a diverter valve connected between an inlet and an outlet of the compressor, the diverter valve comprising:
a housing forming a cylinder;
a piston arranged within the cylinder;
an inlet aperture passing from an exterior of the housing into the cylinder;
an outlet aperture passing from the exterior of the housing into the cylinder; and
a conduit configured to provide a pressurized fluid to the cylinder via the inlet aperture such that the fluid acts to move the piston within the cylinder to at least one of cover or uncover the outlet aperture.

12. The turbocharger of claim 11 further comprising a resilient member arranged and configured to bias a position of the piston within the cylinder.

13. The turbocharger of claim 12, wherein the biased position of the piston causes the piston to at least one of cover or uncover the outlet aperture.

14. The turbocharger of claim 12, wherein the resilient member comprises a coil spring.

15. The turbocharger of claim 14, wherein the coil spring comprises a canted coil spring.

16. The turbocharger of claim 14, wherein the coil spring comprises a helical coil spring.

17. The turbocharger of claim 11, wherein the housing comprises a first half connected to a second half.

18. The turbocharger of claim 17, wherein each of the first and second halves comprise a flange, and wherein the flange of the first half is connected to the flange of the second half.

19. The turbocharger of claim 11, wherein the housing comprises a nipple protruding from and configured to releasably connect the housing to the conduit.

20. An internal combustion engine comprising:
an intake manifold;
a turbocharger comprising a turbine and a compressor operatively connected to the turbine; and
a diverter valve connected between an inlet and an outlet of the compressor, the diverter valve comprising:
a housing forming a cylinder;
a piston arranged within the cylinder;
an inlet aperture passing from an exterior of the housing into the cylinder;
an outlet aperture passing from the exterior of the housing into the cylinder; and
a conduit in fluid communication with the cylinder via the inlet aperture and connected to the intake manifold such that a fluid pressure within the intake manifold acts to move the piston within the cylinder to at least one of cover or uncover the outlet aperture.
